(19) United States
(12) Patent Application Publication
(10) Pub. No.: US 2024/0290353 A1
(43) Pub. Date: Aug. 29, 2024

(54) VIDEO EDITING METHOD, APPARATUS, AND NON-TRANSITORY COMPUTER-READABLE STORAGE MEDIUM

(71) Applicant: LEMON INC., GRAND CAYMAN (KY)

(72) Inventor: Xiaotong MA, Beijing (CN)

(21) Appl. No.: 18/396,216

(22) Filed: Dec. 26, 2023

(30) Foreign Application Priority Data
Feb. 28, 2023 (CN) 202310183495.5

(51) Int. Cl. G11B 27/031

(52) U.S. Cl. CPC G11B 27/031

(57) ABSTRACT

The present disclosure relates to a video editing method, a video editing method apparatus, and a non-transitory computer-readable storage medium, and relates to the technical field of multimedia technology. The video editing method includes: displaying a main menu in a video editing interface, wherein the main menu comprises a material entry control; in response to a triggering operation of a user on the material entry control, displaying a material addition control, wherein the triggering operation is any of triggering operation(s) of the user on the material entry control, the triggering operation(s) being used to triggering the display of the material addition control; acquiring a material added by the user in response to a triggering operation of the user on the material addition control; and displaying, in the video editing interface, a material control corresponding to the material added by the user.

### CROSS-REFERENCE TO RELATED APPLICATIONS

The present disclosure is based on and claims priority of Chinese application for invention No. 202310183495.5, filed on Feb. 28, 2023, the disclosure of which is hereby incorporated into this disclosure by reference in its entirety.

### TECHNICAL FIELD

The present disclosure relates to the technical field of multimedia technology, and in particular, to a video editing method, a video editing method apparatus, and a non-transitory computer-readable storage medium.

### BACKGROUND

A user can, through video editing software, perform clip of a video, and add materials such as sound, text and special effects for the video to enrich presentation content of the video.

A main menu of a video editing interface comprises controls corresponding to various types of materials such as sound, text, and special effects, and by triggering these controls, addition controls and editing controls for the materials can be further displayed using one or more menu levels.

### SUMMARY

According to a first aspect of some embodiments of the present disclosure, there is provided a video editing method, comprising: displaying a main menu in a video editing interface, wherein the main menu comprises a material entry control; in response to a triggering operation of a user on the material entry control, displaying a material addition control, wherein the triggering operation is any of triggering operation(s) of the user on the material entry control, the triggering operation(s) being used to triggering the display of the material addition control; acquiring a material added by the user in response to a triggering operation of the user on the material addition control; and displaying, in the video editing interface, a material control corresponding to the material added by the user.

In some embodiments, the material addition control is displayed in a form of a floating menu, the floating menu comprising a plurality of material addition items, each of the material addition items corresponding to a material addition manner.

In some embodiments, the video editing method further comprises: after the floating menu is displayed, closing the floating menu in response to a triggering operation of the user on a blank area or the material entry control in the video editing interface.

In some embodiments, the acquiring the material added by the user in response to the triggering operation of the user on the material addition control comprises: displaying a material addition panel in response to a triggering operation of the user on a material addition item in the floating menu; and determining the material added by the user according to an interaction operation of the user with the material addition panel.

In some embodiments, the material addition items correspond to multiple material addition manners of adding a sound file, adding recording, or adding a sound effect in response to the material entry control being a sound entry control; or, the material addition items correspond to material addition manners of adding input text and adding a subtitle in response to the material entry control being a text entry control.

In some embodiments, the material addition control is a material addition panel.

In some embodiments, the material entry control is a picture-in-picture entry control or a special effect entry control.

In some embodiments, the displaying the material control corresponding to the material added by the user comprises: displaying a thumbnail control, wherein the thumbnail control is associated with a plurality of material controls and occupies a secondary track; and displaying the plurality of material controls associated with the thumbnail control in response to a triggering operation of the user on the thumbnail control, wherein the plurality of material controls occupy one or more secondary tracks.

In some embodiments, the plurality of material controls associated with the thumbnail control are displayed in response to the triggering operation of the user on the thumbnail control, and the plurality of material controls are in an unselected state.

In some embodiments, the displaying the plurality of material controls associated with the thumbnail control in response to the triggering operation of the user on the thumbnail control comprises: determining a video time point corresponding to a triggering point of the user on the thumbnail control in response to the triggering operation of the user on the thumbnail control; moving a main track and the one or more secondary tracks to locate the video time point at a target position; and displaying, in the moved one or more secondary track, the plurality of material controls associated with the thumbnail control.

In some embodiments, the plurality of material controls associated with the thumbnail control belong to a same type, wherein material controls of the same type are added through a same material entry control.

In some embodiments, a style of the thumbnail control corresponds to the type to which the material controls associated with the thumbnail control belong, the style comprising at least one of a texture, an icon, or a character.

In some embodiments, the displaying the plurality of material controls associated with the thumbnail control in response to the triggering operation of the user on the thumbnail control comprises: displaying the plurality of material controls associated with the thumbnail control and a material editing component and hiding the main menu in response to the triggering operation of the user on the thumbnail control, wherein the material editing component comprises one or more material editing controls.

In some embodiments, the video editing method further comprises: hiding the main menu and displaying a material editing component in response to a triggering operation of the user on the material control or in response to displaying the material control corresponding to the material added by the user, wherein the material editing component comprises one or more material editing controls.

In some embodiments, the material editing component further comprises a return control for closing the material editing component and displaying the main menu.

In some embodiments, the video editing method further comprises: closing the material editing component and displaying the main menu in response to a triggering operation of the user on a blank area in the video editing interface.

In some embodiments, the video editing method further comprises: decreasing brightness of an un-triggered material control or increasing transparency of the un-triggered material control in response to the triggering operation of the user on the material control.

In some embodiments, the video editing method further comprises: moving the material control to a target secondary track in response to a moving operation of the user on the material control.

In some embodiments, the displaying a material control corresponding to the material added by the user comprises: displaying, in a secondary track, the material control corresponding to the material added by the user.

In some embodiments, the video editing method further comprises: in response to the plurality of material controls being located on a same secondary track and having a temporal overlap, determining a layer sequence of the material controls according to a sequence of adding the material controls, and displaying the plurality of added material controls according to the layer sequence.

According to a second aspect of some embodiments of the present disclosure, there is provided a video editing apparatus comprising: a memory; and a processor coupled to the memory, the processor being configured to perform, based on instructions stored in the memory, any of the video editing methods described above.

According to a third aspect of some embodiments of the present disclosure, there is provided a non-transitory computer-readable storage medium having thereon stored a computer program which, when executed by a processor, implements any of the video editing methods described above.

Other features of the present disclosure and advantages thereof will become apparent from the following detailed description of exemplary embodiments thereof, which proceeds with reference to the accompanying drawings.

### BRIEF DESCRIPTION OF THE DRAWINGS

In order to more clearly illustrate the embodiments of the present disclosure or the technical solutions in the prior art, the drawings that need to be used in the description of the embodiments or the prior art will be briefly described below, and it is obvious that the drawings in the following description are only some embodiments of the present disclosure, and for those skilled in the art, other drawings may be obtained according to the drawings without paying inventive labor.

FIG. 1 illustrates a schematic flow diagram of a video editing method according to some embodiments of the present disclosure.

FIGS. 2A to 2D exemplarily illustrates schematic diagrams of a video editing interface.

FIG. 3 illustrates a schematic structural diagram of a video editing apparatus according to some embodiments of the present disclosure.

FIG. 4 illustrates a schematic structural diagram of a video editing apparatus according to other embodiments of the present disclosure.

FIG. 5 illustrates a schematic structural diagram of a video editing apparatus according to further embodiments of the present disclosure.

### DETAILED DESCRIPTION

The technical solutions in the embodiments of the present disclosure will be described clearly and completely in conjunction with the drawings in the embodiments of the present disclosure, and it is obvious that the embodiments described are only some embodiments of the present disclosure, rather than all embodiments. The following description of at least one exemplary embodiment is merely illustrative in nature and is in no way intended to limit this disclosure and its application or uses. All other embodiments, which are obtained by those skilled in the art based on the embodiments of the present disclosure without making creative labor, shall fall within the scope of protection of the present disclosure.

The relative arrangements, numerical expressions and numerical values of components and steps set forth in these embodiments do not limit the scope of the present disclosure unless specifically stated otherwise.

Meanwhile, it should be understood that a size of each portion shown in the drawings is not drawn according to an actual scale for the convenience of description.

Techniques, methods, and devices known to one of ordinary skill in the related art might not be discussed in detail but the techniques, methods, and devices should be considered as part of the description where appropriate.

In all examples shown and discussed herein, any specific value should be construed as exemplary only and not as limiting. Therefore, other examples of the exemplary embodiment may have different values.

It should be noted that: similar reference numbers and letters refer to similar items in the following drawings, and thus, once a certain item is defined in one drawing, it need not be discussed further in subsequent drawings.

In the related art, when a user triggers a control in a main menu for the first time and triggers the control in the main menu for the non-first time, different results will be obtained. For example, when a user clicks “special effects” in a main menu for the first time, a special effect selection panel is directly invoked for the user to select a special effect for addition; and when the user clicks “special effects” again, a submenu will be invoked, in which a button of “add special effects” is comprised so that the user needs to click “add special effects” to invoke the special effect selection panel again. Therefore, the same operation on the same material entry might bring different feedback, which makes it difficult for users to understand and even brings confusion to some users. This increases a probability of user misoperation, and then reduces efficiency of video editing.

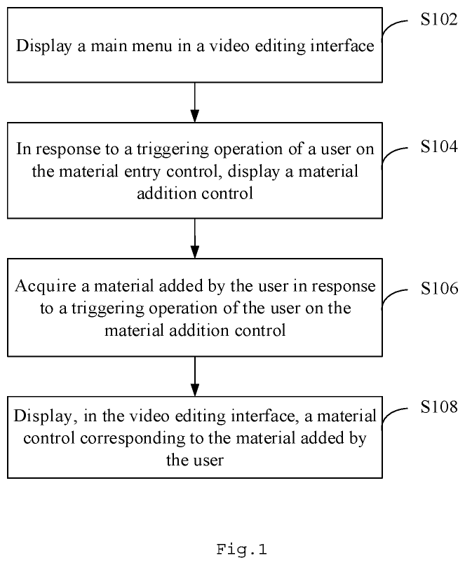

FIG. 1 illustrates a schematic flow diagram of a video editing method according to some embodiments of the present disclosure. This embodiment can be executed by a terminal, for example, a mobile phone, a tablet computer, a personal computer, and the like. As shown in FIG. 1, the video editing method of this embodiment comprises steps S102 to S108.

In step S102, a main menu is displayed in a video editing interface, wherein the main menu comprises a material entry control.

The main menu, which may also be referred to as a root menu, has one or more material entry controls deployed thereon. In some embodiments, each of the one or more material entry controls corresponds to one type of materials, for example, the main menu may comprise entry control(s) corresponding to at least one type of audio, text, picture-in-picture, special effect, etc.

In step S104, in response to a triggering operation of a user on the material entry control, a material addition control is displayed, wherein the triggering operation is any of triggering operation(s) of the user on the material entry control, the triggering operation(s) being used to triggering the display of the material addition control. The triggering operation of the user is, for example, a click operation, or the like.

That is, a first trigger, a second trigger, and any possibly-generated subsequent trigger on a certain material entry control, all give the user the same feedback. However, for different material entry controls, different material addition controls may be displayed after the triggers.

For example, for a material entry control 1, after the user performs any trigger of multiple times of triggers on this control, a material addition control 1 is displayed; and for a material entry control 2, after the user performs any trigger of multiple times on this control, a material addition control 2 is displayed. The material addition control 1 and the material addition control 2 may be the same or different, which is not limited in this disclosure.

In step S106, a material added by the user is acquired in response to a triggering operation of the user on the material addition control.

The user can select the material that he/she desires to add into a video. For example, the user selects a picture from a local picture library, selects a piece of music from a network music library, selects a special effect from a special effect library, and so on.

In step S108, in the video editing interface, a material control is displayed corresponding to the material added by the user.

The material control is a triggerable control, and may be an operation entry for the material, for example, an entry to perform operations such as editing and deleting, to facilitate more flexible control of the user over the added material.

In some embodiments, brightness of an un-triggered material control is decreased or transparency of the un-triggered material control in increased in response to the triggering operation of the user on the material control. In addition, a triggered material control can be subjected to processing beneficial to focusing of the user, such as highlighting and adding a selection box, so that the user can make sure the currently processed object, and a probability of misoperation is reduced.

In addition to adding the material control, an effect that the added material is applied to the edited video may be viewed in real time through a preview window.

In the embodiments of the present disclosure, the material entry is taken as an entry to add the material, and the material addition control is displayed regardless of the number of triggers of the user on the material entry. Therefore, the feedback of the user on the operation for the material entry in the main menu is definite, which is easy for the user to understand and reduces a probability of user misoperation, so that efficiency of the video editing is improved. In this way, both terminal resources and network resources of the user can be saved.

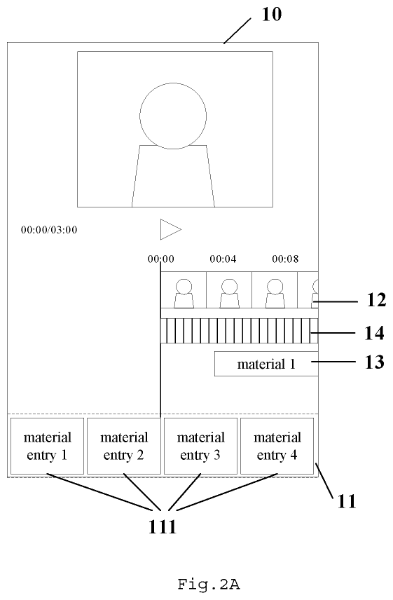

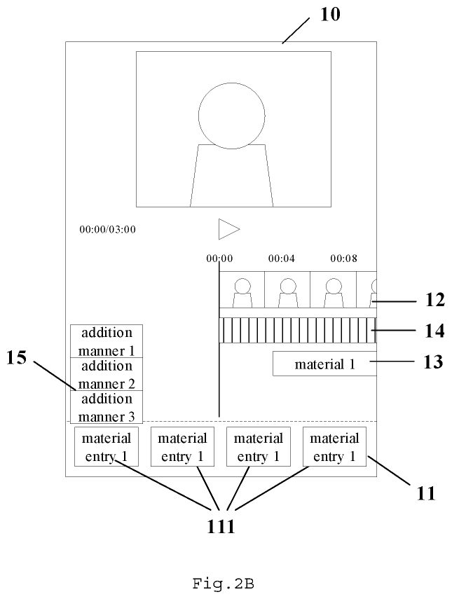

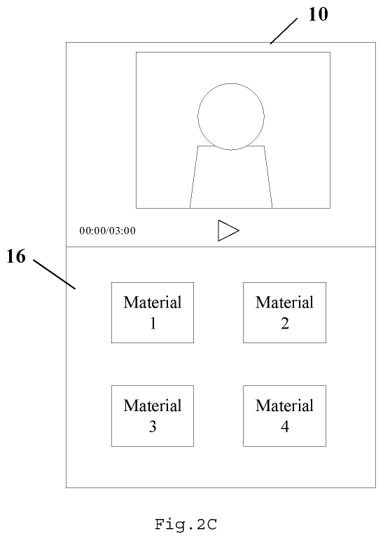

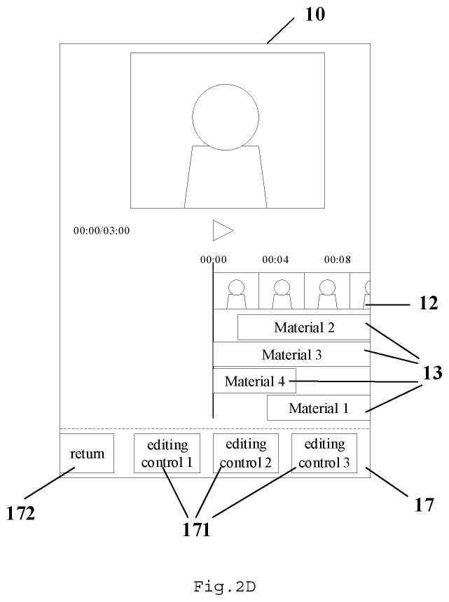

FIG. 2A exemplarily illustrates a schematic diagram of a video editing interface in a state. As shown in FIG. 2A, the video editing interface 10 comprises a main menu 11 in which a plurality of material entry controls 111 are comprised, for example, material entry controls corresponding to a material entry 1, a material entry 2, a material entry 3, and a material entry 4.

In some embodiments, the material addition control is displayed in a form of a floating menu, the floating menu comprising a plurality of material addition items, each of the material addition items corresponding to a material addition manner. When the floating menu is displayed, the main menu is still in a display state.

For example, the material entry 1 in FIG. 2A corresponds to a plurality of addition manners, such as addition manners 1 to 3. After the user triggers the material entry 1, the video editing interface 10 may, as shown in FIG. 2B, over the material entry 1, display a floating menu 15, where material addition items corresponding to the three addition manners are comprised. A specific location of the floating menu is not limited to the manner shown in FIG. 2B, and can be set by those skilled in the art as needed.

The material addition control is presented by using the floating menu, so that the material addition function of the material entry is represented more clearly and definitely, and in the case where the main menu is not closed, the user can be further prompted to select the material addition manner, which clarifies the level of the menu, reduces a probability of user misoperation, so that efficiency of the video editing is improved.

In some embodiments, after the floating menu is displayed, the floating menu is closed in response to a triggering operation of the user on a blank area or the material entry control in the video editing interface. The blank area refers to an area that does not comprise any control. Therefore, the user can, in many more and more concise manners, return to the level of the main menu from the state that the material is to be added, which reduces a probability of user misoperation, so that efficiency of the video editing is improved.

In some embodiments, a material addition panel is displayed in response to a triggering operation of the user on a material addition item in the floating menu; and the material added by the user is determined according to an interaction operation of the user with the material addition panel. The material addition panel may be a selection panel (comprising a plurality of materials to be selected) or an input panel (comprising controls for inputting text, sound, and other content), which may occupy a partial or entire area of the video editing interface.

For example, after the user clicks the addition manner 1 in the floating menu 15 of FIG. 2B, the video editing interface 10 may display a material addition panel 16 as shown in FIG. 2C. If the user selects a material 3, the material 3 will be added into the edited video. Meanwhile, in the video editing interface 10, a material control corresponding to the material 3 may be displayed.

From the above process, it can be seen that for the material with the plurality of the addition manners, the user determines, after triggering the material entry control, the added material through the operations on the two controls for the floating menu and the material addition panel. However, since the floating menu coexists with the main menu in the form of floating, no visual jump is brought to the user in the processes of displaying the floating menu and operating the floating menu. Therefore, understanding cost of the user is reduced, and convenience of user interaction is improved.

In some embodiments, the material with the plurality of addition manners is sound or text. For example, for a sound entry control, the addition manner comprises more than one of adding a sound file (e.g., adding locally or from a network), adding recording (e.g., invoking a recording function for the user to record audio immediately), or adding a sound effect (e.g., adding from a sound effect library provided by a video editing application). For another example, for a text entry control, the addition manner comprises entering text and adding a subtitle. Therefore, for the material type with a variety of material sources, such as sound or text, more choices can be provided to the user, to improve flexibility of the video editing.

In some embodiments, the material addition control is a material addition panel. For example, in the case where a material corresponding to the material entry has one addition manner, a material addition panel is displayed in response to a triggering operation of the user on the material entry control, wherein the triggering operation is any of triggering operation(s) of the user on the material entry control, the triggering operation(s) being used to triggering the display of the same material addition panel. For example, it is assumed that a material corresponding to the material entry 3 in FIG. 2A has only one addition manner. After the user triggers the material entry 3, the video editing interface 10 can jump directly to a state in FIG. 2C, i.e. displaying the material addition panel 16, without comprising any other menu level therein. Therefore, the user can directly invoke the material addition panel by triggering the material entry control, so that the menu level is simplified, and efficiency of the video editing is improved.

In some embodiments, in a case where the material entry control is a picture-in-picture entry control or a special effect entry control, the material addition control is the material addition panel. Materials of picture-in-picture and special effect types have single acquisition paths, so that addition processes of the materials of the two types can be simplified.

The video editing interface may comprise a main track and secondary track(s). The main track is used for displaying a control corresponding to the edited video (or referred to as a main video), and the secondary track(s) are used for displaying the material control(s) corresponding to the material(s) added into the main video. The tracks has a timeline to represent content of the main video or material at a same time point.

As shown in FIG. 2A, the main video is located in a main track 12, and in the secondary track, there is a material control 13, for example, a material control corresponding to a material 1 is comprised, the material 1 starts to function from the 3rd second of the video.

In some embodiments, a plurality of secondary tracks may be compressed. In some embodiments, a thumbnail control is displayed, wherein the thumbnail control is associated with a plurality of material controls and occupies a secondary track; and the plurality of material controls associated with the thumbnail control are displayed in response to a triggering operation of the user on the thumbnail control, wherein the plurality of material controls occupy one or more secondary tracks.

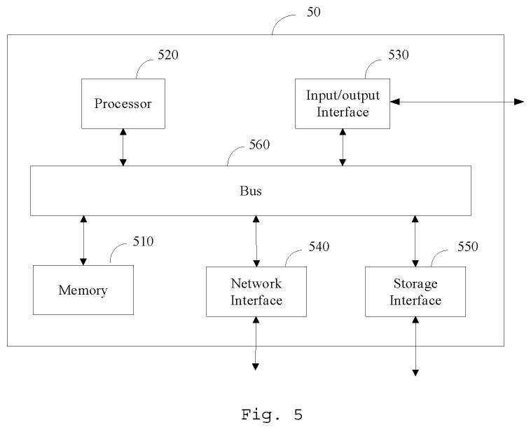

For example, in FIG. 2A, a thumbnail control 14 is associated with materials 2, 3, and 4 and occupies one secondary track. When the user triggers the thumbnail control 14, as shown in FIG. 4D, the thumbnail control 14 is hidden, and material controls 13 corresponding to the materials 2, 3, and 4 are displayed, and each material control occupies one track.

The thumbnail control also occupies one secondary track, so that it is in a same form as the track occupied by an ordinary material. In this way, the user can easily understand that the content contained therein are materials, so it is easy for the user to search and determine the material control that he desires to operate, and reduces a probability of misoperation. Moreover, in a case of more materials, the video editing interface can be simplified. Therefore, efficiency of the video editing is improved.

In some embodiments, the plurality of material controls associated with the thumbnail control are displayed in response to the triggering operation of the user on the thumbnail control, and the plurality of material controls are in an unselected state. That is, after the user triggers the thumbnail control, any of the material controls is not selected by default. Misoperation caused by default selection of a certain material control in the case where the user only wants to browse the compressed material controls is avoided. Therefore, efficiency of the video editing can be improved.

The compressed material controls may be part or all of the material controls added by the user. For example, the compressed material controls are of a same type. A style of the thumbnail control may correspond to the type to which its associated material controls belong, the style comprising at least one of a texture, an icon, or a character. For example, for material controls of a sound type, a thumbnail control thereof can have a texture with an audio waveform, to enable the user to clearly and quickly know content therein, so that a probability of user misoperation is reduced.

In some embodiments, a video time point corresponding to a triggering point of the user on the thumbnail control is determined in response to the triggering operation of the user on the thumbnail control; a main track and the one or more secondary tracks are moved to locate the video time point at a target position; and in the moved one or more secondary track, the plurality of material controls associated with the thumbnail control are displayed. Therefore, the position triggered by the user can be moved to the target position, for example, a central axis of the video editing interface, so that a position interested by the user can be subjected to clearer presentation.

In some embodiments, the material control is moved to a target secondary track in response to a moving operation of the user on the material control. For example, in a case where there are a plurality of tracks for picture-in-picture materials, a certain picture-in-picture material control can be moved to another secondary track through long pressing and a moving operation, which can facilitate user's control and management of the material, so that a probability of misoperation is reduced.

In some embodiments, in response to the plurality of material controls being located on a same secondary track and having a temporal overlap, a layer sequence of the material controls is determined according to a sequence of adding the material controls, and the plurality of added material controls are displayed according to the layer sequence. Therefore, the user can determine the sequence of adding the materials according to a superposition effect of the material controls, which can facilitate user's control and management of the materials, so that a probability of misoperation is reduced.

The embodiments of the present disclosure also exemplarily provide several manners of material editing.

In some embodiments, in response to a triggering operation of the user on the thumbnail control, the plurality of material controls associated with the thumbnail control and a material editing component are displayed, and the main menu is hidden, wherein the material editing component comprises one or more material editing controls.

As shown in FIGS. 2A and 2D, when the material controls 13 corresponding to the materials 2, 3, and 4 are displayed by triggering, by the user, the thumbnail control 14, a material editing component 17 is simultaneously displayed, which comprise three editing controls 171, namely, editing controls 1 to 3 respectively. For example, when the user triggers a sound-type thumbnail control, while materials associated with the thumbnail control are displayed, an editing control for sound, such as volume, speed, and gradual change, can also be displayed, thereby facilitating the user quickly knowing the editing manner for the material and entering an editable state. Therefore, efficiency of the video editing is improved.

In some embodiments, in response to the triggering operation of the user on the material control, the main menu is hidden and the material editing component is displayed, wherein the material editing component comprises one or more material editing controls. Taking FIG. 2D as an example, when the user triggers any material control in material controls of materials 1 to 4, a material editing control corresponding to the material control may be displayed, for example, a sound editing control is displayed for a sound material, a text editing control is displayed for a text material, and the like.

In some embodiments, the main menu is hidden and the material editing component is displayed in response to displaying the material control corresponding to the material added by the user, wherein the material editing component comprises one or more material editing controls. Therefore, after a certain material is added by the user, an editing state of the material is automatically entered, to facilitate the user quickly editing the material just added.

The embodiments of the present disclosure also exemplarily provide two embodiments of closing the material editing component. These two approaches may be implemented alternatively, or jointly, in a video editing application.

In some embodiments, the material editing component further comprises a return control for closing the material editing component and displaying the main menu. The return control may be illustrated as a control 172 of FIG. 2D. This approach is easy for the user to understand.

In some embodiments, the material editing component is closed and the main menu is displayed in response to a triggering operation of the user on the blank area in the video editing interface. The operation area for this approach is large, so that a probability of misoperation of the user is low.

Another closing approach may be used by those skilled in the art as needed, and will not be described herein.

According to the above embodiment, the video editing interface directly jumps to the main menu without passing through the material addition control when the material editing component is closed. That is, according to the embodiment of the present disclosure, the separation processing of the menus for material addition and material editing is realized, which simplifies the menu level, and improves efficiency of the video editing.

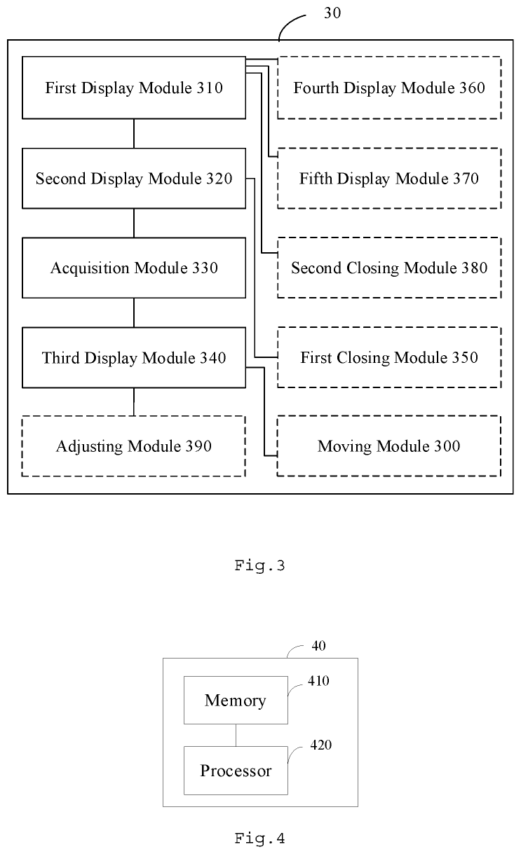

An embodiment of a video editing apparatus of the present disclosure is described below with reference to FIG. 3.

FIG. 3 illustrates a schematic structural diagram of a video editing apparatus according to some embodiments of the present disclosure. As shown in FIG. 3, the video editing apparatus 30 of this embodiment comprises: a first display module 310 configured to display a main menu in a video editing interface, wherein the main menu comprises a material entry control; a second display module 320 configured to, in response to a triggering operation of a user on the material entry control, display a material addition control, wherein the triggering operation is any of triggering operation(s) of the user on the material entry control, the triggering operation(s) being used to triggering the display of the material addition control; an acquisition module 330 configured to acquire a material added by the user in response to a triggering operation of the user on the material addition control; and a third display module 340 configured to display, in the video editing interface, a material control corresponding to the material added by the user.

In some embodiments, the material addition control is displayed in a form of a floating menu, the floating menu comprising a plurality of material addition items, each of the material addition items corresponding to a material addition manner.

In some embodiments, the video editing apparatus 30 further comprises: a first closing module 350 configured to, after the floating menu is displayed, close the floating menu in response to a triggering operation of the user on a blank area or the material entry control in the video editing interface.

In some embodiments, the acquisition module 330 is further configured to display a material addition panel in response to a triggering operation of the user on a material addition item in the floating menu; and determine the material added by the user according to an interaction operation of the user with the material addition panel.

In some embodiments, the material addition items correspond to multiple material addition manners of adding a sound file, adding recording, or adding a sound effect in response to the material entry control being a sound entry control; or, the material addition items correspond to material addition manners of adding input text and adding a subtitle in response to the material entry control being a text entry control.

In some embodiments, the material addition control is a material addition panel.

In some embodiments, the material entry control is a picture-in-picture entry control or a special effect entry control.

In some embodiments, the third display module 340 is further configured to display a thumbnail control, wherein the thumbnail control is associated with a plurality of material controls and occupies a secondary track; and display the plurality of material controls associated with the thumbnail control in response to a triggering operation of the user on the thumbnail control, wherein the plurality of material controls occupy one or more secondary tracks.

In some embodiments, the third display module 340 is further configured to display the plurality of material controls associated with the thumbnail control in response to the triggering operation of the user on the thumbnail control, and the plurality of material controls are in an unselected state.

In some embodiments, the third display module 340 is further configured to determine a video time point corresponding to a triggering point of the user on the thumbnail control in response to the triggering operation of the user on the thumbnail control; move a main track and the one or more secondary tracks to locate the video time point at a target position; and display, in the moved one or more secondary track, the plurality of material controls associated with the thumbnail control.

In some embodiments, the plurality of material controls associated with the thumbnail control belong to a same type, wherein material controls of the same type are added through a same material entry control.

In some embodiments, a style of the thumbnail control corresponds to the type to which the material controls associated with the thumbnail control belong, the style comprising at least one of a texture, an icon, or a character.

In some embodiments, the third display module 340 is further configured to display the plurality of material controls associated with the thumbnail control and a material editing component and hiding the main menu in response to the triggering operation of the user on the thumbnail control, wherein the material editing component comprises one or more material editing controls.

In some embodiments, the video editing apparatus 30 further comprises: a fourth display module 360 configured to, hide the main menu and displaying a material editing component in response to a triggering operation of the user on the material control, wherein the material editing component comprises one or more material editing controls.

In some embodiments, the video editing apparatus 30 further comprises: a fifth display module 370 configured to hide the main menu and displaying a material editing component in response to displaying the material control corresponding to the material added by the user, wherein the material editing component comprises one or more material editing controls.

In some embodiments, the material editing component further comprises a return control for closing the material editing component and displaying the main menu.

In some embodiments, the video editing apparatus 30 further comprises: a second closing module 380 configured to close the material editing component and display the main menu in response to a triggering operation of the user on a blank area in the video editing interface.

In some embodiments, the video editing apparatus 30 further comprises: an adjusting module 390 configured to decrease brightness of an un-triggered material control or increase transparency of the un-triggered material control in response to the triggering operation of the user on the material control.

In some embodiments, the video editing apparatus 30 further comprises: a moving module 300 configured to move the material control to a target secondary track in response to a moving operation of the user on the material control.

In some embodiments, the third display module 340 is further configured to display, in a secondary track, the material control corresponding to the material added by the user.

In some embodiments, the third display module 340 is further configured to, in response to the plurality of material controls being located on a same secondary track and having a temporal overlap, determine a layer sequence of the material controls according to a sequence of adding the material controls, and displaying the plurality of added material controls according to the layer sequence.

FIG. 4 illustrates a schematic structural diagram of a video editing apparatus according to other embodiments of the present disclosure. As shown in FIG. 4, the video editing apparatus 40 of this embodiment comprises: a memory 410 and a processor 420 coupled to the memory 410, the processor 420 being configured to perform, based on instructions stored in the memory 410, the video editing method according to any of the above embodiments.

The memory 410 may comprise, for example, a system memory, a fixed non-volatile storage medium, and the like. The system memory has thereon stored, for example, an operating system, an application, a boot loader, other programs, and the like.

FIG. 5 illustrates a schematic structural diagram of a video editing apparatus according to further embodiments of the present disclosure. As shown in FIG. 5, the video editing apparatus 50 of this embodiment comprises: a memory 510 and a processor 520, and may further comprise an input/output interface 530, a network interface 540, a storage interface 550, and the like. These interfaces 530, 540, 550 and the memory 510 may be connected with the processor 520, for example, through a bus 560. The input/output interface 530 provides a connection interface for input/output devices such as a display, a mouse, a keyboard, and a touch screen. The network interface 540 provides a connection interface for various networking devices. The storage interface 550 provides a connection interface for external storage devices such as an SD card and a USB flash disk.

The embodiments of the present disclosure further provide a non-transitory computer-readable storage medium having a computer program stored thereon, characterized in that the program, when executed by a processor, implements any of the above video editing methods.

It should be appreciated by those skilled in the art that, the embodiments of the present disclosure may be provided as a method, system, or computer program product. Accordingly, the present disclosure may take a form of an entire hardware embodiment, an entire software embodiment, or an embodiment combining software and hardware aspects. Moreover, the present disclosure may take a form of a computer program product implemented on one or more computer-usable non-transitory storage media (including, but not limited to, a disk memory, CD-ROM, optical memory, etc.) having computer-usable program code embodied therein.

The present disclosure is described with reference to flow diagrams and/or block diagrams of the method, apparatus (system) and computer program product according to the embodiments of the present disclosure. It should be understood that each flow and/or block of the flow diagrams and/or block diagrams, and a combination of flows and/or blocks in the flow diagrams and/or block diagrams, can be implemented by computer program instructions. These computer program instructions may be provided to a processor of a general-purpose computer, special-purpose computer, embedded processor, or other programmable data processing devices to produce a machine, such that the instructions which are executed through the processor of the computer or other programmable data processing devices create means for implementing the functions specified in one or more flows of the flow diagrams and/or one or more blocks of the block diagrams.

These computer program instructions may also be stored in a computer-readable memory that can guide a computer or other programmable data processing devices to work in a specific manner, such that the instructions stored in the computer-readable memory produce an article of manufacture including instruction means which implement the functions specified in one or more flows of the flow diagrams and/or one or more blocks of the block diagrams.

These computer program instructions may also be loaded onto a computer or other programmable data processing devices to cause a series of operational steps to be performed on the computer or other programmable devices to produce a computer-implemented process, such that the instructions which are executed on the computer or other programmable devices provide steps for implementing the functions specified in one or more flows of the flow diagrams and/or one or more blocks of the block diagrams.

The above description is only preferred embodiments of the present disclosure and not used for limiting the present disclosure, and any modifications, equivalent substitutions, improvements and the like that are made within the spirit and scope of the present disclosure should be comprised within the scope of protection of the present disclosure.

What is claimed is:

1. A video editing method, comprising:
displaying a main menu in a video editing interface, wherein the main menu comprises a material entry control;
in response to a triggering operation of a user on the material entry control, displaying a material addition control, wherein the triggering operation is any of triggering operation(s) of the user on the material entry control, the triggering operation(s) being used to triggering the display of the material addition control;
acquiring a material added by the user in response to a triggering operation of the user on the material addition control; and
displaying, in the video editing interface, a material control corresponding to the material added by the user.

2. The video editing method according to claim 1, wherein the material addition control is displayed in a form of a floating menu, the floating menu comprising a plurality of material addition items, each of the material addition items corresponding to a material addition manner.

3. The video editing method according to claim 2, further comprising:
after the floating menu is displayed, closing the floating menu in response to a triggering operation of the user on a blank area or the material entry control in the video editing interface.

4. The video editing method according to claim 2, wherein the acquiring the material added by the user in response to the triggering operation of the user on the material addition control comprises:
displaying a material addition panel in response to a triggering operation of the user on a material addition item in the floating menu; and
determining the material added by the user according to an interaction operation of the user with the material addition panel.

5. The video editing method according to claim 2, wherein:
the material addition items correspond to multiple material addition manners of adding a sound file, adding recording, or adding a sound effect in response to the material entry control being a sound entry control; or,
the material addition items correspond to material addition manners of adding input text and adding a subtitle in response to the material entry control being a text entry control.

6. The video editing method according to claim 1, wherein the material addition control is a material addition panel.

7. The video editing method according to claim 6, wherein the material entry control is a picture-in-picture entry control or a special effect entry control.

8. The video editing method according to claim 1, wherein the displaying the material control corresponding to the material added by the user comprises:
displaying a thumbnail control, wherein the thumbnail control is associated with a plurality of material controls and occupies a secondary track; and
displaying the plurality of material controls associated with the thumbnail control in response to a triggering operation of the user on the thumbnail control, wherein the plurality of material controls occupy one or more secondary tracks.

9. The video editing method according to claim 8, wherein:
the plurality of material controls associated with the thumbnail control are displayed in response to the triggering operation of the user on the thumbnail control, and the plurality of material controls are in an unselected state; or
the displaying the plurality of material controls associated with the thumbnail control in response to the triggering operation of the user on the thumbnail control comprises:
determining a video time point corresponding to a triggering point of the user on the thumbnail control in response to the triggering operation of the user on the thumbnail control;
moving a main track and the one or more secondary tracks to locate the video time point at a target position; and
displaying, in the moved one or more secondary track, the plurality of material controls associated with the thumbnail control.

10. The video editing method according to claim 8, wherein the plurality of material controls associated with the thumbnail control belong to a same type, wherein material controls of the same type are added through a same material entry control.

11. The video editing method according to claim 10, wherein a style of the thumbnail control corresponds to the type to which the material controls associated with the thumbnail control belong, the style comprising at least one of a texture, an icon, or a character.

12. The video editing method according to claim 10, wherein the displaying the plurality of material controls associated with the thumbnail control in response to the triggering operation of the user on the thumbnail control comprises:
displaying the plurality of material controls associated with the thumbnail control and a material editing component and hiding the main menu in response to the triggering operation of the user on the thumbnail control, wherein the material editing component comprises one or more material editing controls.

13. The video editing method according to claim 1, further comprising:
hiding the main menu and displaying a material editing component in response to a triggering operation of the user on the material control or in response to displaying the material control corresponding to the material added by the user, wherein the material editing component comprises one or more material editing controls.

14. The video editing method according to claim 12, wherein the material editing component further comprises a return control for closing the material editing component and displaying the main menu.

15. The video editing method according to claim 12, further comprising:
closing the material editing component and displaying the main menu in response to a triggering operation of the user on a blank area in the video editing interface.

16. The video editing method according to claim 1, further comprising:
decreasing brightness of an un-triggered material control or increasing transparency of the un-triggered material control in response to the triggering operation of the user on the material control; or
moving the material control to a target secondary track in response to a moving operation of the user on the material control.

17. The video editing method according to claim 1, wherein the displaying a material control corresponding to the material added by the user comprises:
displaying, in a secondary track, the material control corresponding to the material added by the user.

18. The video editing method according to claim 8, further comprising:
in response to the plurality of material controls being located on a same secondary track and having a temporal overlap, determining a layer sequence of the material controls according to a sequence of adding the material controls, and displaying the plurality of added material controls according to the layer sequence.

19. A video editing apparatus comprising:
a memory; and
a processor coupled to the memory, the processor being configured to perform, based on instructions stored in the memory, the video editing method comprising:
displaying a main menu in a video editing interface, wherein the main menu comprises a material entry control;
in response to a triggering operation of a user on the material entry control, displaying a material addition control, wherein the triggering operation is any of triggering operation(s) of the user on the material entry control, the triggering operation(s) being used to triggering the display of the material addition control;
acquiring a material added by the user in response to a triggering operation of the user on the material addition control; and
displaying, in the video editing interface, a material control corresponding to the material added by the user.

20. A non-transitory computer-readable storage medium having thereon stored a computer program which, when executed by a processor, implements the video editing method comprising:
displaying a main menu in a video editing interface, wherein the main menu comprises a material entry control;
in response to a triggering operation of a user on the material entry control, displaying a material addition control, wherein the triggering operation is any of triggering operation(s) of the user on the material entry control, the triggering operation(s) being used to triggering the display of the material addition control;
acquiring a material added by the user in response to a triggering operation of the user on the material addition control; and
displaying, in the video editing interface, a material control corresponding to the material added by the user.
